(19) United States
(12) Patent Application Publication
(10) Pub. No.: US 2026/0162964 A1
(43) Pub. Date: Jun. 11, 2026

(54) METHOD FOR PRODUCING COPPER-RICH SILICON FOAMS FROM AT LEAST BINARY MIXED PHASES

(71) Applicant: NORCSI GMBH, Halle (DE)

(72) Inventors: Udo REICHMANN, Wilsdruff (DE); Marcel NEUBERT, Kreischa (DE); Andreas KRAUSE-BADER, Dresden (DE)

(73) Assignee: NORCSI GMBH, Halle (DE)

(21) Appl. No.: 18/706,523

(22) PCT Filed: Nov. 3, 2022
(86) PCT No.: PCT/EP2022/080662

§ 371 Date: May 1, 2024

(30) Foreign Application Priority Data
Nov. 3, 2021 (DE) 10 2021 128 565.8
Dec. 23, 2021 (DE) 10 2021 134 516.2

(51) Int. Cl. H01M 4/1395; H01M 4/02; H01M 4/04; H01M 4/36; H01M 4/38; H01M 10/0525

(52) U.S. Cl. CPC H01M 4/1395; H01M 4/0423; H01M 4/0471; H01M 4/366; H01M 4/386; H01M 10/0525; H01M 2004/021; H01M 2004/027

(57) ABSTRACT

The invention relates to a method for producing copper-rich silicon foams from at least binary mixed phases, wherein a silicon layer structure is applied onto a support substrate. The aim of the invention is to provide an alternative method for using nanoparticles and nanowires which allows the production of copper-rich silicon foams that can preferably be used as a high-capacity electrode material in rechargeable batteries. This is achieved in that one layer of the silicon layer structure is made of at least two plies and at least two materials, said materials having different diffusion constants, and the layer is subjected to a rapid annealing process with a controlled energy input, wherein cavity structures with different diameters are formed.

The invention relates to a process for producing copper-rich silicon foams from at least binary mixed phases, in which a silicon ply structure is applied to a support substrate.

The invention further relates to the use of the process of the invention for producing a high-capacity electrode material in a lithium-ion battery, more particularly for a silicon anode and also an anode material, and to the use thereof in a battery cell and in a lithium-ion battery.

The aim of the invention is the formation of a porous silicon-rich layer that is electrically highly conductive and permits good diffusion for lithium. An intrinsic porosity in the layer would allow ongoing compensation of the expansion in volume that occurs when lithium is intercalated, without loss of electrical contact with the support substrate. In addition, a stable and unchanging surface would be advantageous when using such a layer as an electrode in a battery application to the electrolyte.

The theoretical background is described with reference to the Si-Cu-Ni mixed system as follows. Various nickel silicide phases undergo a change in volume during their formation (Simon, M. et al. Lateral Extensions to Nanowires for Controlling Nickel Silicidation Kinetics: Improving Contact Uniformity of Nanoelectronic Devices. ACS Appl. Nano Mater. 4, 4371-4378 (2021) ; Tang, W., Nguyen, B.-M., Chen, R. and Dayeh, S. A. Solid-state reaction of nickel silicide and germanide contacts to semiconductor nanochannels. Semicond. Sci. Technol. 29, 054004(2014 ) ).

Whereas silicon-rich NiSix phases have only low volume expansion, this is all the more higher in nickel-rich NiSix phases. Ni₂Si in particular shows a volume up to 200% greater than pure crystalline silicon.

It has been demonstrated that in a copper-nickel-silicon (Cu-Ni-Si) system, during an annealing process, a nickel silicide is initially formed that then undergoes complete conversion into a copper silicide. Physically, it is the different enthalpies of formation of the different silicides that are the drivers of these reactions. If the process time is such that adequate material transport is not possible (not at equilibrium), then voids, pores or cavities are left behind. This results in the creation of a foam-like silicide structure. In addition, if two or more metals having different rates of diffusion are present, a further effect termed the Kirkendall effect occurs. It is known from Kim, D., Chang, J., Park, J. and Pak, J. J. Formation and behavior of Kirkendall voids within intermetallic layers of solder joints. J Mater Sci: Mater Electron 22, 703-716 (2011) that cavities in the submicrometer range known as Kirkendall voids form in intermetallic compounds in solder joints. This observed effect has an adverse effect on the adhesion of the solder contact. If too many Kirkendall voids occur at an interface, structural adhesion is reduced and the contact is lost.

To categorize how the process of the invention can be used to advantage in battery production and in lithium-ion batteries in particular, a brief introductory explanation of the structure of these batteries will be given.

Batteries are electrochemical energy storage devices and a distinction is made between primary and secondary batteries. Primary batteries are electrochemical power sources in which chemical energy is irreversibly converted into electrical energy. A primary battery is thus not rechargeable.

Secondary batteries, also termed accumulators, are on the other hand rechargeable electrochemical energy storage devices in which the chemical reaction that occurs is reversible, which means that repeated use is possible. Electrical energy is converted into chemical energy when charging and in turn from chemical to electrical energy when discharging.

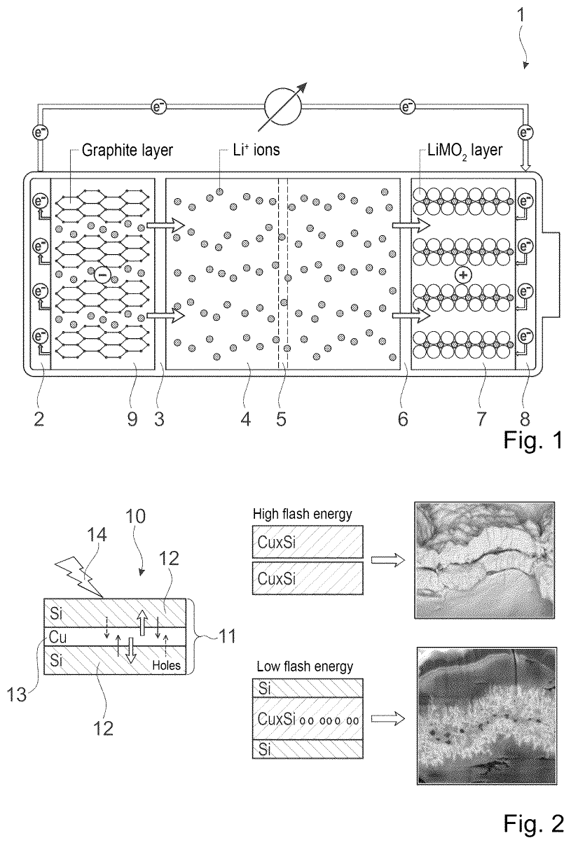

Battery is the generic term for an array of cells connected together. Cells are galvanic units that consist of two electrodes, electrolyte, separator, and cell housing. FIG. 1 shows an exemplary structure and the function of a lithium-ion cell during the discharge process. The components of a cell are explained in brief hereinbelow.

Each Li-ion cell consists of two different electrodes, an electrode that in the charged state is negatively charged and an electrode that in the charged state is positively charged. During energy release, i.e. during discharge, ions migrate from the negatively charged electrode to the positively charged electrode, consequently the positively charged electrode is termed the cathode and the negatively charged electrode the anode. The electrodes are each composed of a current conductor (also termed a collector) and an active material applied thereon, the active layer. Between the electrodes are, firstly, the ion-conducting electrolyte, which permits the necessary charge exchange, and the separator, which ensures the electrical separation of the electrodes.

The cathode consists for example of mixed oxides applied on an aluminum collector.

The anode of a Li-ion cell can consist of a copper foil as collector and a layer of carbon or silicon as active material. During the charging process, lithium ions are reduced and intercalated into the graphite or silicon layers.

In structures for lithium-ion batteries (LiB), the cathode typically supplies the lithium atoms for charging and discharging in the anode, consequently the battery capacity is limited by the cathode capacity. Examples of typical cathode materials used up to now are Li (Ni, Co, Mn) O₂ and LiFePO₄. Because the cathode is formed from lithium-metal oxides that provide the lithium ions to be intercalated when the cell is discharging, there is only minimal scope for increasing the capacity.

The capacity of the battery is determined by the thickness of the active layer, or more particularly of the Si layer. The electrical conductivity of the active material must be set as high as possible in a battery. Silicon, being a semiconductor, has only poor conductivity, unlike conductive graphite. Therefore, silicon requires high doping or structures that increase electrical conductivity. A standard practice is for nanoscale silicon powders to be encased in carbon-containing scaffold structures and fixed to the power collector.

Challenges that arise when using silicon as an electrode material include the sometimes considerable change in volume (volume contraction and expansion) of the host matrix during the intercalation and deintercalation of the mobile ion species (lithium) during charging and discharging of corresponding energy storage devices. The change in volume is approx. 10% for graphite and, by contrast, up to 300% for silicon and as high as 400% for the theoretical Li₂₂Si₅ phase. This expansion in volume of silicon at full lithium storage of 3579 mAh/g is unavoidable. The change in the volume of the electrode material when using silicon in a battery application leads to internal stresses, cracking, pulverization of the active material and ultimately to the complete loss of electrode capacity.

To compensate for the change in volume, known processes for producing batteries employ carbon-or silicon-based nanoparticles and nanowires as anode materials in rechargeable lithium batteries. The major advantage of such nanomaterials, besides the increase in the rate of lithium intercalation and deintercalation, is the surface effect. This can be understood as meaning that, when there is a large surface area, the contact surface area for the electrolyte and the associated flow of Li+ions (voids) through the interface is increased, as described in the publication M. R. Zamfir, H. T. Nguyen, E. Moyen, Y. H. Leeac and D. Pribat: Silicon nanowires for Li-based battery anodes: a review, Journal of Materials Chemistry A (a review), 1, 9566(2013 ). Although silicon-based nanoparticles and nanowires in particular have smaller storage capacities of approx. 3400 mAh/g compared to the maximum possible storage capacity of silicon of 3579 mAh/g, up to a certain size of Si structure they exhibit more stable silicon structures in respect of the change in volume of the silicon after intercalation of the lithium, as described in the publication M. Green, E. Fielder, B. Scrosati, M. Wachtier and J. S. Moreno: Structured silicon anodes for lithium battery applications, Electrochem. Solid-State Lett, 6, A 75-A79 (2003). The structural limit is considered to be 1 μm for amorphous silicon and 100 nm for crystalline silicon, in order for it to be possible for an even change in volume to occur.

Thus, not only can the expansion in volume of the electrode material be absorbed by the free space between the nanostructures, the reduction in size of the structures facilitates the phase transitions during alloy formation, which results in an increase in performance of the electrode material.

The utilization of silicon-based nanoparticles and nanowires is however very complex. The Si nanostructures are produced by both physical and chemical processes, including milling in ball mills (ball milling), deposition by sputtering, PVD/CVD processes, chemical and electrochemical etching and reduction of SiO₂ (Feng, K. et al. Silicon-Based Anodes for Lithium-Ion Batteries: From Fundamentals to Practical Applications. Small 14, 1702737(2018 ) ). In the prior art, the nanostructures produced are then mixed with conductive carbon and binder and, in industrial anode construction, applied to a copper power collector by calendering and drying. The disadvantage of these processes is that the nanostructures separate from one another when the battery is in operation, resulting in a loss of anode capacity. A further disadvantage is the high surface area of the nanostructures, which results in a large consumption of electrolyte and in the battery drying out.

Up to now, it has been possible to produce alternatively suitable Si-Cu cavity structures for lithium-ion batteries only by complex furnace processes (He, Y., Wang, Y., Yu, X., Li, H. and Huang, X. Si-Cu Thin Film Electrode with Kirkendall Voids Structure for Lithium-Ion Batteries. J. Electrochem. Soc. 159, A 2076(2012 ).

It is therefore an object of the present invention to provide a process that offers an alternative to the use of nanoparticles and nanowires and with which copper-rich silicon foams can be produced that can preferably be used as high-capacity electrode material in rechargeable batteries. The properties of the layers produced by the process should be selectively varied and tailored to the respective use through adjustment of the process parameters and the process should be executable as simply, quickly, and efficiently as possible.

The object is achieved by a process as claimed in independent claim 1. In the process for producing copper-rich silicon foams from at least binary mixed phases, in which a silicon ply structure is applied to a support substrate, a ply of the silicon ply structure composed of at least two layers and of at least two or more materials is formed and applied, wherein the materials have different diffusion constants, and that the ply is subjected to short-cycle annealing with a selective input of energy, wherein cavity structures of varying diameter are formed.

Short-cycle annealing is understood as meaning in particular flash-lamp annealing and/or laser annealing. Flash-lamp annealing is carried out with a pulse duration or annealing time in the range of from 0.3 to 20 ms and pulse energy in the range of from 0.3 to 100 J/cm² . In laser annealing, the annealing time is adjusted from 0.01 to 100 ms through the scan speed of the local heating point, so as to produce an energy density of from 0.1 to 100J/cm² . The heating ramps achieved in short-cycle annealing are within the range of from 10\hat{ }4-10\hat{ }7 K/s that is necessary in the process. Flash-lamp annealing employs for this purpose a spectrum in the visible wavelength range, whereas laser annealing uses discrete wavelengths in the infrared (IR) to ultraviolet (UV) spectrum.

A ply is understood as meaning a layer stack that is formed from at least two layers. A ply therefore comprises at least two layers. A ply is constructed from at least two different materials, it being possible for a ply to be formed from, for example, two silicon layers and a copper layer, i.e. the ply in this example comprises a Si-Cu-Si layer stack.

After short-cycle annealing, the simple stacking of different layers into a ply of two or more materials creates cavities that go beyond those of the effect described by Kirkendall. Through the formation of various intermetallic phases, sometimes simultaneously, sometimes successively, having different densities or lattice parameters, it is possible for time-dependent processes to be controlled by short-cycle annealing with process parameters that are adjustable in a defined manner.

The process of the invention permits the formation of a porous silicide-silicon matrix in which amorphous or nanoscale silicon occurs together with cavities or pores.

These basic process steps give rise to an enormous range of parameters that can be selectively optimized for applications in which the layer produced is to be used. Short-cycle annealing in particular provides a decisive advantage on account of the selective energy input. Short-cycle annealing allows diffusion processes in the mixed layers to be controlled and permits stabilization of non-equilibrium states that are not in a state of equilibrium.

In one variant of the process of the invention, the ply composed of at least copper and silicon, Cu-Si, is deposited. The deposition of Cu and Si takes place layer by layer, wherein the short-cycle annealing results in Cu and Si then reacting to form a binary mixed phase.

In another variant of the process of the invention, the ply composed of copper, silicon and a further material, Cu-Si-X, is deposited. The materials are deposited layer by layer, wherein the short-cycle annealing results in the materials then reacting to form a ternary mixed phase when three different materials are used.

In a further variant of the process of the invention, the further material is nickel (Ni), titanium (Ti), aluminum (Al), tin (Sn), germanium (Ge), lithium (Li), tungsten (W) and/or carbon (C).

When, in a variant of the process of the invention, nickel is also deposited as a further material in addition to Cu and Si, the short-cycle annealing initially gives rise to a nickel silicide that then undergoes complete conversion into a copper silicide.

This creates a foam-like silicide structure that is suitable for use as an active layer in a lithium-ion battery, in order to produce a stable anode for lithium-ion batteries. By controlling the energy of the flash lamp and/or laser, it is possible to control the size of the cavity structures that are formed in order that the mechanical contact of the active layer with the substrate is maintained despite the cavities formed. The cavities then reduce the expansion in volume of the silicon anode during lithium intercalation.

In a further variant of the process of the invention, the short-cycle annealing is a flash-lamp annealing and the flash-lamp annealing controls the formation of the cavity structures by means of a pulse duration in the range of from 0.3 to 20 ms and/or a pulse energy in the range of from 0.3 to 100 J/cm 2 in the flash-lamp annealing and by preheating or cooling the support substrate in the range of from 4° C. to 200° C.

When laser annealing is used as short-cycle annealing, the formation of the cavity structures is controlled through an annealing time in the range of from 0.01 to 100 ms, through setting a scan speed of a local heating point and setting an energy density in the range of from 0.1 to 100 J/cm² , and by preheating or cooling in the range of from 4° C. to 200° C. in the laser annealing, thereby producing part-reacted silicon in each ply.

In the process of the invention it is possible to deposit any desired layer stack, i.e. plies composed of metals having different diffusion constants, for example by sputtering or evaporation processes. A layer stack forms a ply. A ply structure is formed from two or more plies. Additional annealing processes can be carried out quickly and efficiently in a wide range of options by varying the pulse energy of the flash/laser, the pulse time of the flash/laser and/or the preheating or cooling of the substrate.

In one variant of the process of the invention, more than one ply is applied to the support substrate for the silicon ply structure, wherein each ply is deposited in an individually adjustable layer thickness. Within a ply, each layer is deposited in an individually adjustable layer thickness. A deposited ply can be repeatedly deposited as a further ply using the employed process parameters or different ones.

In another variant of the process of the invention, the silicon ply structure has stable cavity structures that are formed through a removal of lithium previously introduced or that form during operation of a silicon anode consisting of an electrode material formed by the silicon ply structure, through the introduction and removal of lithium.

In a further variant of the process of the invention, the silicon ply structure has stable cavity structures that are formed in a size and number determined in a self-regulating manner by the rate of lithium diffusion. In addition to lithium intercalation, which leaves behind cavity structures, the number and size of these structures can be influenced by the rate of charging, i.e. the nature of use. This means, more particularly, by the charge/discharge rate of a battery or by the operating mode or use of the battery in general. In C. Heubner, U. Langklotz, A. Michaelis, Theoretical optimization of electrode design parameters of Si based anodes for lithium-ion batteries, J. Energy Storage, volume 15, 2018, pages 181-190, it is shown that the possible diffusion rates depend on the porosity of the silicon anode, which is adjusted in a self-regulating manner in the process of the invention.

The introduction of lithium results in the formation of the cavity structures in the mixed phase system. A stable cavity structure in each ply/in the overall ply structure is formed irreversibly when lithium is removed. Other mixed phases, in the form of an intermediate reaction, are possible. A suitable layer stack composed of Cu-Si (-X) mixed phases expands irreversibly during lithium intercalation here, but in a mechanically stable manner. The high adhesion of the overall ply structure to the support substrate and the use of mixed phases having a heterogeneous structure composed of silicon embedded in silicide structures makes it possible for stable cavity structures to form here. The introduction and removal of lithium can advantageously also take place during the initial cycles (forming) in the operation of the battery. The cavity structure is able to completely absorb the expansion in volume of silicon during lithiation and delithiation. It is therefore possible for the cavity structure formed by the totality of the active layer to be larger than the 300% development in volume (for Li₂₂Si₅ theoretically as high as 400%) due to pure lithium silicide formation. Depending on how much lithium is absorbed, the expansion of the silicon is always the same. It is physically the case that the expansion in volume is equal to the amount stored. The cavity structure, which ultimately absorbs the expansion, can thus be significantly larger than the pure expansion of silicon. What is important is that the cavity structure must be stable. The special feature of the process of the invention is that the cavity structure is produced both during production in the flash-lamp process and during the “initial” operation of a battery, and thereafter remains stable. According to the invention, this is made possible by providing a suitable conductive and extensible scaffold of the mixed phase system. This creates cavities in the ply structure of variable size and number (porosity). By way of example, SEM images of a ply of Si-Cu mixed layers after cycling are appended (FIG. 4 to FIG. 6), which show a thickness of 10 μm of an originally 1 μm thick Si layer. High-resolution SEM investigations permitted the additional measurement here, in addition to the macroscopic pores (100 nm to 2 μm), of pore sizes having an average value of 10 nm and a porosity of 7-15%. Investigations by positron annihilation spectroscopy permitted the detection too of voids in the 0.5 to 2 nm range, depending on the selected process parameters.

The advantage of the process of the invention for battery applications is that it makes a variable stack structure for adjusting the cavity structures possible without additional complexity. Different material systems can be combined in order to adjust the number of cavities formed. In the layer structure here, a planar surface with minimal roughness is expedient for the formation of a stable protective layer. The cavities, the size of which spans the nanoscale and microscale size ranges, ensure a stable layer both during manufacture and during the expansion in volume caused by lithium intercalation.

In a further variant of the process of the invention, each ply is subjected to an individual short-cycle annealing. This allows the cavity structures for each ply of the silicon ply structure to be adjusted individually.

The use of short-cycle flash-lamp or laser annealing technology in the process of the invention allows the energy input into the layer to be selectively controlled. The formation of Kirkendall cavities is a diffusion-driven process that is adjusted through the energy input per unit time.

The process of the invention allows selective use to be made of transient intermediate phases, i.e. where reactions have not proceeded to completion, and of short-lived lattice structures and makes it possible to use for this purpose any desired combinations of materials having different diffusion constants to form cavities having different diameters. This allows each ply to be constructed individually and the properties thereof to be selectively influenced in order to adjust battery performance.

It is therefore advantageous to use the process of the invention for producing copper-rich silicon foams as claimed in claims 1 to 11 for producing a high-capacity electrode material in a lithium-ion battery, more particularly for a silicon anode.

It is additionally advantageous to produce an anode material for an electrochemical cell, more particularly a lithium-ion battery.

This anode material can be used in a battery cell, which in turn can be installed in a battery having at least one battery cell.

The advantage of the process of the invention is that the described properties are not created and achieved by complicated processes, but result naturally from the selective use of short-cycle annealing. This takes place in a single process step and is highly scalable and therefore extremely cost-effective. Other processes are significantly more complex, require much more energy than the flash-lamp annealing, and cannot be applied in a scalable manner.

The invention will be elucidated more particularly in the following exemplary embodiment.

The drawings show

FIG. 1 Exemplary structure and function of a lithium-ion cell during the discharge process;

FIG. 2 Schematic representation of a ply formed from two materials and the formation of the copper-rich silicon foams as a function of the short-cycle annealing parameters employed;

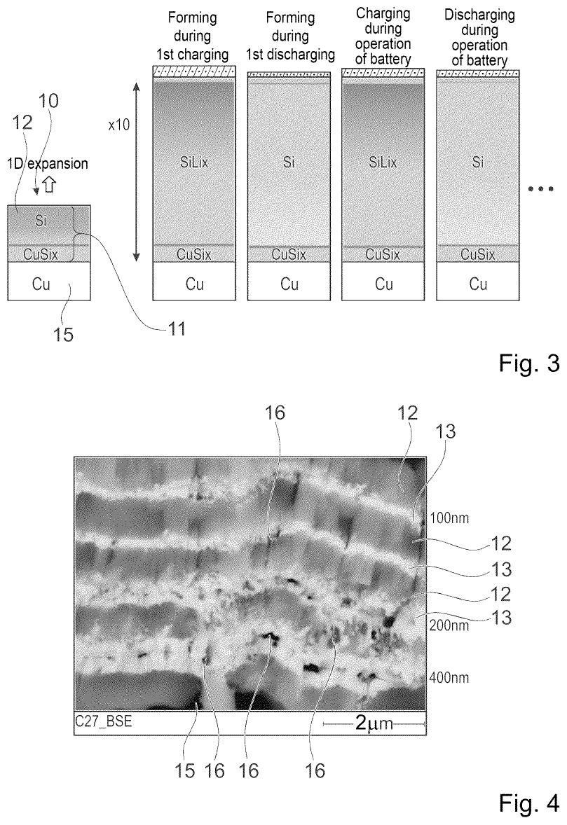

FIG. 3 Schematic representation of the process of the invention in a configuration in which the cavity structures are formed by an introduction and removal of lithium;

FIG. 4 SEM image of cavity structures in a Si ply structure formed from a binary mixed system of Cu and Si;

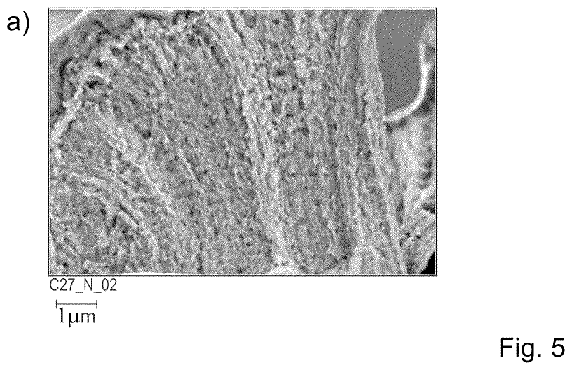

FIG. 5 SEM image of a Si ply structure of the invention during forming (initial cycles and intercalation of Li in Si);

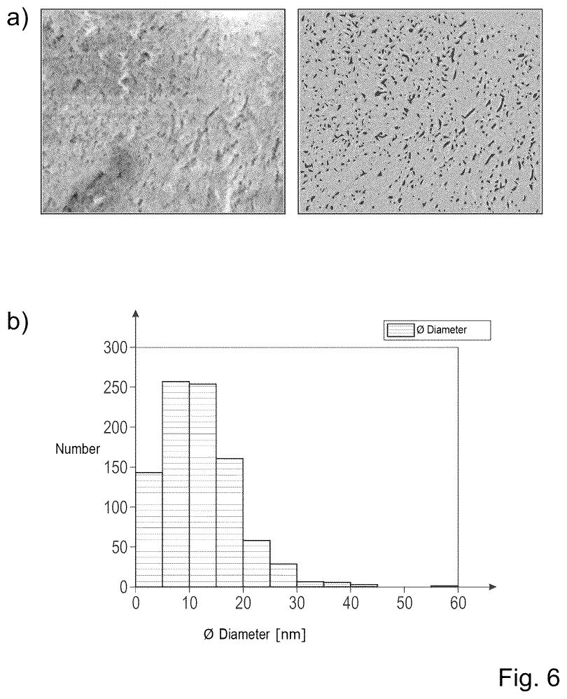

FIG. 6 High-resolution SEM image a) of a cycled Si multi-ply anode, which shows a porosity of 7-15% with an average diameter of 10 nm for the pore size b).

FIG. 2 shows a schematic representation of a produced copper-rich silicon foam, where a ply 11 of the silicon ply structure 10 is in the depicted example formed from a stack of three layers composed of the materials Si-Cu-Si 12-13-12. Short-cycle annealing 14 results in the formation of a porous silicide matrix containing large proportions of amorphous silicon that is ideally suited as a high-capacity electrode material to mitigate the expansion in volume of silicon caused by lithium intercalation. At the same time, the conductive silicide matrix forms a stable scaffold, so as to ensure a solid electrical contact with the power collector, thus enabling continuous operation of the battery. The cavity structures are able to form because the rate of diffusion of Cu in Si is much higher than that of Si in Cu; D_{cu in Si}>>D_{si in cu}. In a state of thermal equilibrium, the following approximation applies: D_{Cu in Si}≈D_{voids}+D_{Si in Cu}.

FIG. 3 shows a schematic representation of the process of the invention in a configuration in which the cavity structures are formed by an introduction and removal of lithium. When the process of the invention for producing copper-rich silicon foams is used for producing a high-capacity electrode material in a lithium-ion battery, more particularly for a silicon anode, the ply structure 10 produced expands by a factor of 10 during an initial forming as a consequence of the introduction of lithium. This expansion in volume is maintained during discharging, because a stable cavity structure has formed. In the further operation of the battery, lithium is again able to undergo intercalation in the formed cavity structure.

FIG. 4 shows a SEM image of cavity structures in a Si ply structure 10, wherein the Si ply structure 10 is formed from a binary mixed system of Cu and Si. All layers sputtered onto a support substrate 15 are visible. The gradual increase in the individually adjustable Cu layer thicknesses 13 during the production process is likewise visible. Intermediate flashes in flash-lamp annealing or laser annealing 14 result in diffusion of Cu into the Si and formation of the cavity structures 16 (as an example). The thicker the Cu layer 13, the larger the cavities.

FIG. 5 shows the SEM image of a Si ply structure of the invention during forming (initial cycles and intercalation of Li in Si) and the structure of a stable cavity structure having microscopic cavities that absorbs the expansion in volume of the silicon. The scaffold has a high content of copper, which ensures a constant high electrical conductivity.

FIG. 6 shows a) the high-resolution image of a multi-ply Si anode after operation of the battery. A porosity of 15% was determined. The size of the cavities shown here is in the 2 nm to 50 nm range (FIG. 6b). The median of the depicted cavities determined by visual evaluation is 10 nm.

In one embodiment, the silicon ply structures containing copper and nickel show a significant increase in layer thickness after short-cycle annealing that is not attributable solely to an expansion in volume caused by crystallization or oxidation (FIG. 5). Measurements show a structure (FIG. 6) containing both macroscopic and microscopic cavities down to the nanoscopic size range. When used as electrode material in batteries, the foam structures that are formed result in an improvement in battery performance, since they are able to compensate for the change in volume caused by lithium intercalation in the layer.

In the case of incomplete reactions, (transient) intermediate phases may occur that have a lower density or occupy a greater volume of space. However, at the end of the process of the invention, a final conversion into a more compact silicide structure takes place. Because of the short process time, it is not possible for the voids to be filled through diffusion of the missing material here and a (microscale/nanoscale) foam structure forms. These cavity structures can in addition compensate for the expansion in volume of silicon during lithium intercalation. With the inventive process it has been demonstrated that the layer thickness of a material system has increased by a factor of five, although with typical lattice expansions and oxide formation a doubling or tripling is realistic. The remainder of the thicknesses or volume increase is attributed to the cavity structures that are formed.

### REFERENCE SYMBOL LIST

1 Lithium-ion battery
2 Collector on anode side
3 SEI (solid electrolyte interphase)
4 Electrolyte
5 Separator
6 Conductive intermediate phase
7 Cathode, positive electrode
8 Collector on cathode side
9 Anode, negative electrode
10 Silicon ply structure
11 A ply
12 Silicon layer
13 Copper layer
14 Short-cycle annealing step
15 Support substrate
16 Cavity structures

1. A process for producing copper-rich silicon foams from at least binary mixed phases, in which a silicon ply structure is applied to a support substrate (15), characterized in that a ply of the silicon ply structure composed of at least two layers (12, 13) and of at least two materials is formed, wherein the materials have different diffusion constants, and that the ply is subjected to short-cycle annealing with a selective input of energy, wherein cavity structures (16) of varying diameter are formed.

2. The process as claimed in claim 1, characterized in that the ply composed of at least copper and silicon Cu-Si, is deposited.

3. The process as claimed in claim 1, characterized in that the ply composed of copper, silicon and a further material, Cu-X-Si, is deposited.

4. The process as claimed in claim 3, characterized in that the further material is nickel (Ni), titanium (Ti), aluminum (Al), tin (Sn), germanium (Ge), lithium (Li), tungsten (W) and/or carbon (C).

5. The process as claimed in claim 1, characterized in that the further material is nickel and that the short-cycle annealing initially gives rise to a nickel silicide that then undergoes complete conversion into a copper silicide.

6. The process as claimed in claim 1, characterized in that the short-cycle annealing is a flash-lamp annealing and that the flash-lamp annealing controls the formation of the cavity structures by means of a pulse duration in the range of from 0.3 to 20 ms and/or a pulse energy in the range of from 0.3 to 100 J/cm² in the flash-lamp annealing and by preheating or cooling the support substrate in the range of from 4° C. to 200° C.

7. The process as claimed in claim 1, characterized in that the short-cycle annealing is a laser annealing and that the laser annealing controls the formation of the cavity structures through an annealing time in the range of from 0.01 to 100 ms, through setting a scan speed of a local heating point and setting an energy density in the range of from 0.1 to 100J/cm², and by preheating or cooling in the range of from 4° C. to 200° C. in the laser annealing.

8. The process as claimed in claim 1, characterized in that more than one ply is applied to the support substrate for the silicon ply structure wherein each ply is deposited in an individually adjustable layer thickness.

9. The process as claimed in claim 7, characterized in that each ply is subjected to an individual short-cycle annealing

10. The process as claimed in claim 1, characterized in that the silicon ply structure has stable cavity structures that are formed through a removal of lithium previously introduced or that form during operation of a silicon anode consisting of an electrode material formed by the silicon ply structure, through the introduction and removal of lithium.

11. The process as claimed in claim 1, characterized in that the silicon ply structure has stable cavity structures that are formed in a size and number determined in a self-regulating manner by the rate of lithium diffusion.

12. The use of the process for producing copper-rich silicon foams as claimed in claim 1 for producing a high-capacity electrode material in a lithium-ion battery, more particularly for a silicon anode.

13. An anode material for an electrochemical cell, more particularly a lithium-ion battery, produced by the process as claimed in claim 1.

14. A battery cell, more particularly a lithium-ion cell, comprising an anode material as claimed in claim 13.

15. A battery, more particularly a lithium-ion battery, comprising at least one battery cell as claimed in claim 14.
